(19) United States
(12) Patent Application Publication
(10) Pub. No.: US 2023/0011954 A1
(43) Pub. Date: Jan. 12, 2023

(54) DEVICE, METHOD, AND SYSTEM FOR BUSINESS PLAN MANAGEMENT

(71) Applicant: Hitachi, Ltd., Tokyo (JP)

(72) Inventors: Hatem ELSERAFY, Tokyo (JP); Jayesh GUNTUPALLI, Tokyo (JP); Shin TEZUKA, Tokyo (JP); Yoji OZAWA, Tokyo (JP)

(21) Appl. No.: 17/862,219

(22) Filed: Jul. 11, 2022

(30) Foreign Application Priority Data
Jul. 12, 2021 (JP) 2021-114798

(51) Int. Cl. G06Q 10/06; G06N 20/00

(52) U.S. Cl. CPC G06Q 10/06375; G06N 20/00; G06Q 10/06393

(57) ABSTRACT

A business plan generation device including a business plan definition unit configured to define a first business plan for a first business and a set of target business outcomes, a business information acquisition unit configured to acquire a set of business state information that includes at least a set of internal business information or a set of competitor business information, and a business plan generation unit configured to use a machine learning model to generate a set of output data that includes at least a set of revised business plans for achieving the set of target business outcomes, and output the set of output data.

### CROSS-REFERENCE TO RELATED APPLICATIONS

The present application claims priority to Japanese Patent Application No. 2021-114798, filed July 12th, 2021. The contents of this application are incorporated herein by reference in their entirety.

### BACKGROUND OF THE INVENTION

The present disclosure generally relates to generating business plans, and more particularly relates to using business information for competing businesses to generate business plans in the absence of internal business information.

### SUMMARY OF THE INVENTION

The development of feasible business plans is important for businesses of all sizes. Business plans allow businesses to effectively devise business strategies, set priorities, organize personnel, allocate resources, evaluate business performance, and perform a variety of other tasks to facilitate business management. Here, a “business plan” generally refers to a collection of data including a business strategy that characterizes a set of actions to be implemented, a budget that defines an allotment of resources for use in implementing the business strategy, and a set of constraints that define restrictions on implementation of the business strategy.

In recent years, with the rapid progression of cross-industry digitalization and digital service-based enterprises, businesses are required to develop business plans with increasing speed and flexibility in order to remain responsive to the changing needs of customers.

Conventionally, businesses use internal business information to evaluate business plans and assist in the creation of new business plans.

For example, US10783535B2 (Patent Document 1) discloses “In some implementations, an event timeline that includes one or more interactions between a customer and a supplier may be determined. A starting value may be assigned to individual events in the event timeline. A sub-sequence comprising a portion of the event timeline that includes at least one reference event may be selected. A classifier may be used to determine a previous relative value for a previous event that occurred before the reference event and to determine a next relative value for a next event that occurred after the reference event until all events in the event timeline have been processed. The events in the event timeline may be traversed and a monetized value index assigned to individual events in the event timeline.”

Patent Document 1 discloses a technique for creating an event timeline to model interactions between a customer and a supplier and using an artificial intelligence engine to analyze a plurality of data sets relating to the interactions in order to ascertain a value index for each interaction in the event timeline.

In this way, a supplier may gain insight into the value that a customer places on different interactions and use these insights to better respond to customers needs.

The technique disclosed in Patent Document 1, however, relates to determining value indices for interactions between a customer and a supplier, and does not provide a technique for facilitating the automated generation of business plans for a business.

Further, in the technique disclosed in Patent Document 1, the value indices for the interactions between the customer and the supplier are calculated based on internal business data for the business, such as purchase history data, demographic data, website access data, and the like. However, in certain circumstances, such as in the case of a recently established business, internal business data for the business may not be available, which poses challenges for the development of reliable business plans for the business.

Accordingly, it is an object of the present disclosure to provide a device, method, and system for facilitating the automated generation of business plans for a business even in situations in which internal business information is not present.

One representative example of the present disclosure relates to a business plan generation device including a business plan definition unit configured to define a first business plan for a first business and a set of target business outcomes that indicate desired results of the first business plan, a business information acquisition unit configured to acquire a set of business state information that includes at least a set of internal business information that indicates a current state of the first business or a set of competitor business information that indicates a current state of a second business separate from the first business, and a business plan generation unit configured to use a machine learning model to generate, based on the first business plan, the set of target business outcomes, and the set of business state information, a set of output data that includes at least a set of revised business plans for achieving the set of target business outcomes, and output the set of output data.

According to the present disclosure it is possible to provide a device, method, and system for facilitating the automated generation of business plans for a business even in situations in which internal business information is not present.

Problems, configurations, and effects other than those described above will be made clear by the following description in the embodiments for carrying out the invention.

### BRIEF DESCRIPTION OF THE DRAWINGS

FIG. 1 is a block diagram illustrating an example computing architecture for executing the embodiments of the present disclosure.

FIG. 2 is a diagram illustrating an example configuration of a business plan generation system according to embodiments of the present disclosure.

FIG. 3 is a flowchart illustrating a business plan generation method for generating a set of revised business plans, according to embodiments of the present disclosure.

FIG. 4 is a diagram illustrating the flow of data within the business plan generation system according to the embodiments of the present disclosure.

FIG. 5 illustrates the data configuration of the business plan according to the embodiments of the present disclosure.

FIG. 6 is a diagram illustrating an example of the business strategy table according to embodiments of the present disclosure.

FIG. 7 is a diagram illustrating an example of a set of target business outcomes according to the embodiments of the present disclosure.

FIG. 8 is a diagram illustrating an example of a target KPI table according to embodiments of the present disclosure.

FIG. 9 is a diagram illustrating an example configuration of the internal business information management unit according to the embodiments of the present disclosure.

FIG. 10 is a diagram illustrating an example configuration of the competitor business information management unit according to the embodiments of the present disclosure.

FIG. 11 is a diagram illustrating an example of a competitor business information table according to embodiments of the present disclosure.

FIG. 12 is a diagram illustrating an example of a revised competitor business information table according to embodiments of the present disclosure.

FIG. 13 is a diagram illustrating an example configuration of the forecasting unit according to the embodiments of the present disclosure.

FIG. 14 is a diagram illustrating an example of a forecasting data table according to embodiments of the present disclosure.

FIG. 15 is a diagram illustrating an input/output data table that illustrates the input and output data of each functional unit of the business plan generation device according to the embodiments of the present disclosure.

FIG. 16 is a diagram illustrating an example configuration of the business plan generation unit according to the embodiments of the present disclosure.

FIG. 17 is a diagram illustrating the logical configuration of the data elements included in the set of output data according to the embodiments of the present disclosure.

FIG. 18 is a diagram illustrating an output data table according to the embodiments of the present disclosure.

FIG. 19 illustrates a graphical user interface according to the embodiments of the present disclosure.

### DETAILED DESCRIPTION

Hereinafter, embodiments of the present invention will be described with reference to the Figures. It should be noted that the embodiments described herein are not intended to limit the invention according to the claims, and it is to be understood that each of the elements and combinations thereof described with respect to the embodiments are not strictly necessary to implement the aspects of the present invention.

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

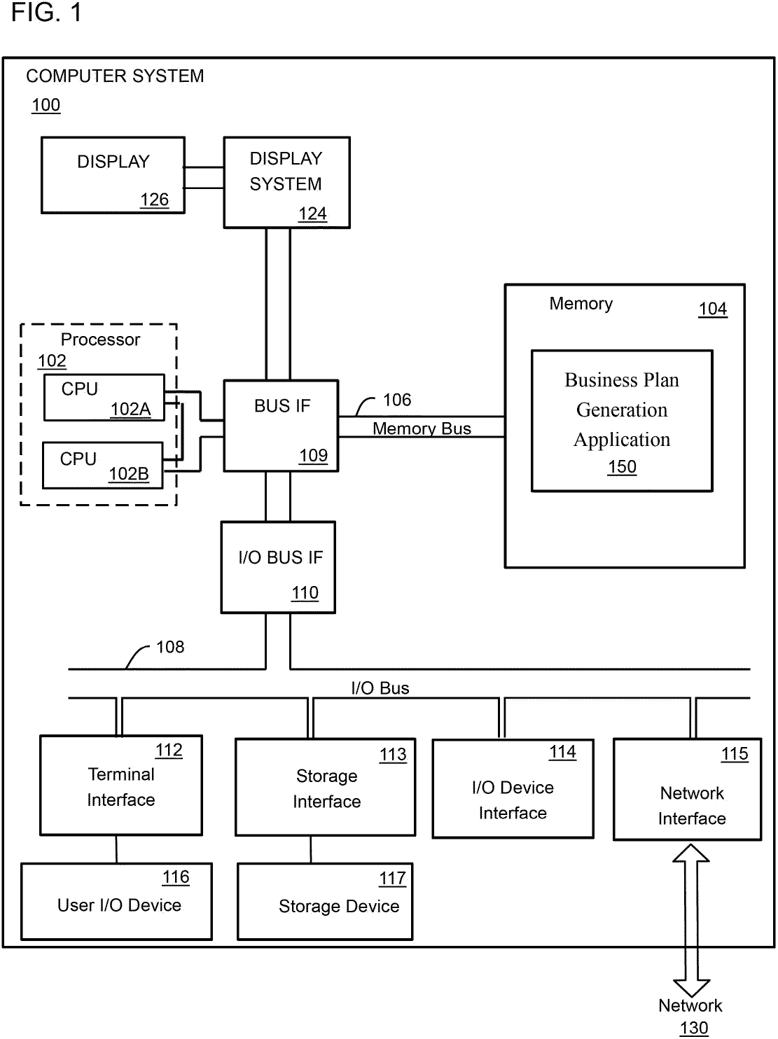

Turning now to the Figures, FIG. 1 depicts a high-level block diagram of a computer system 100 for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 113, an I/O (Input/Output) device interface 114, and a network interface 115, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a business plan generation application 150. In embodiments, the business plan generation application 150 may include instructions or statements that execute on the processor 102 or instructions or statements that are interpreted by instructions or statements that execute on the processor 102 to carry out the functions as further described below.

In certain embodiments, the business plan generation application 150 is implemented in hardware via semiconductor devices, chips, logical gates, circuits, circuit cards, and/or other physical hardware devices in lieu of, or in addition to, a processor-based system. In embodiments, the business plan generation application 150 may include data in addition to instructions or statements. In certain embodiments, a camera, sensor, or other data input device (not shown) may be provided in direct communication with the bus interface unit 109, the processor 102, or other hardware of the computer system 100. In such a configuration, the need for the processor 102 to access the memory 104 and the business plan generation application 150 may be reduced.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 113, 114, and 115, which are also known as I/O processors (IOPs) or I/O adapters (IOAs), through the I/O bus 108. The display system 124 may include a display controller, a display memory, or both. The display controller may provide video, audio, or both types of data to a display device 126. Further, the computer system 100 may include one or more sensors or other devices configured to collect and provide data to the processor 102.

As examples, the computer system 100 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 124 may be coupled with a display device 126, such as a standalone display screen, computer monitor, television, or a tablet or handheld device display.

In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 116, which may include user output devices (such as a video display device, speaker, and/or television set) and user input devices (such as a keyboard, mouse, keypad, touchpad, trackball, buttons, light pen, or other pointing device). A user may manipulate the user input devices using a user interface in order to provide input data and commands to the user I/O device 116 and the computer system 100, and may receive output data via the user output devices. For example, a user interface may be presented via the user I/O device 116, such as displayed on a display device, played via a speaker, or printed via a printer.

The storage interface 113 supports the attachment of one or more disk drives or direct access storage devices 117 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 117 may be implemented via any type of secondary storage device. The contents of the memory 104, or any portion thereof, may be stored to and retrieved from the storage device 117 as needed. The I/O device interface 114 provides an interface to any of various other I/O devices or devices of other types, such as printers or fax machines. The network interface 115 provides one or more communication paths from the computer system 100 to other digital devices and computer systems; these communication paths may include, for example, one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

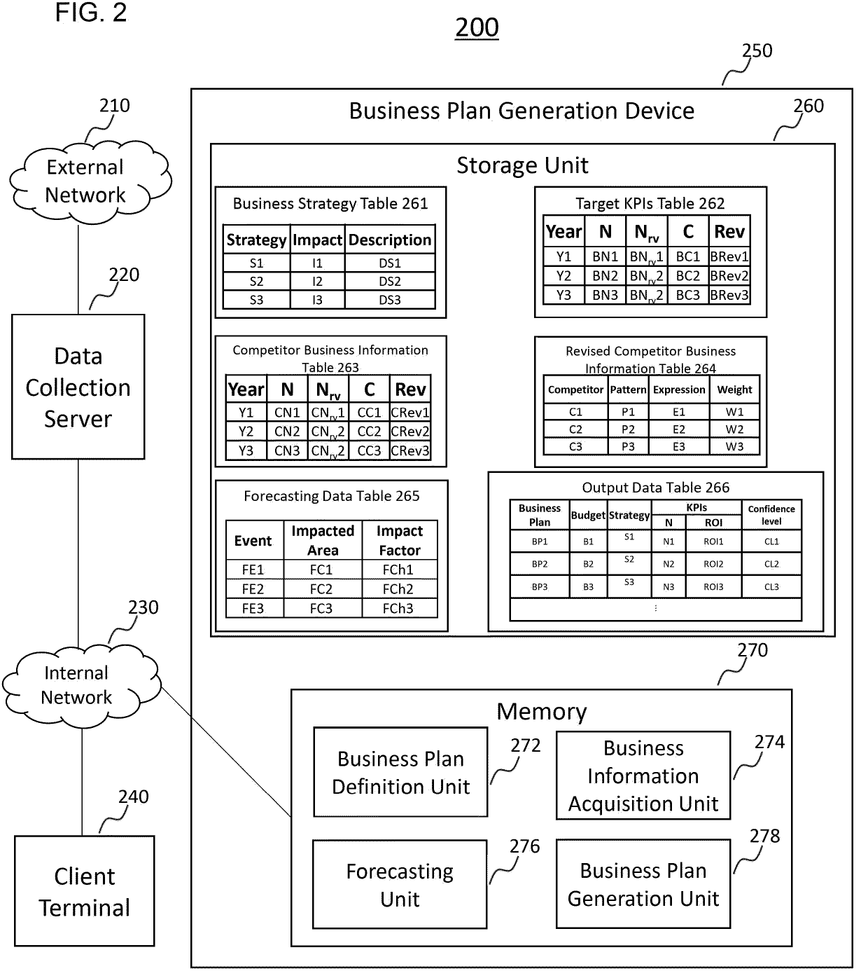

Next, an example configuration of a business plan generation system according to embodiments of the present disclosure will be described with reference to FIG. 2.

FIG. 2 is a diagram illustrating an example configuration of a business plan generation system 200 according to embodiments of the present disclosure. As illustrated in FIG. 2, the business plan generation system 200 primarily includes an external network 210, a data collection server 220, an internal network 230, a client terminal 240, and a business plan generation device 250.

The external network 210 is a communication network that may be used for data collection. The external network 210 may be a communication network that consists of private, public, academic, business, and government networks of local to global scope, linked by a broad array of electronic, wireless, and optical networking technologies. In embodiments, the external network 210 may be used for collection of business information (for example, a set of competitor business information). As an example, the external network 210 may be the Internet.

The data collection server 220 is a server device configured to facilitate the collection of data from the external network 210. The data collection server 220 may perform one or more data collection operations with respect to the external network 210 (e.g., based on instructions of the business information acquisition unit 274). As an example, the data collection server 220 may be used to collect a set of competitor business information from the external network 210 based on instructions of the business information acquisition unit 274.

The internal network 230 is a network for facilitating data communication between the data collection server 220, the client terminal 240, and the business plan generation device 250. As examples, the internal network 230 may include a Local Area Network (LAN) connection, a Wide Area Network (WAN) connection, a Metropolitan Area Network (MAN) connection or the like configured to enable mutual communication between the data collection server 220, the client terminal 240, and the business plan generation device 250. The internal network 230 may transmit a set of competitor business information collected by the data collection server 220 to the business plan generation device 250, and transmit a set of output data from the business plan generation device 250 to the client terminal 240.

The client terminal 240 is a device for use by a client (e.g., user) of the business plan generation device 250. The client terminal 240 may display a graphical user interface (see FIG. 19) for receiving input data to the business plan generation device 250 and presenting output data from the business plan generation device 250. As examples, the client terminal 240 may include a desktop computer, a laptop computer, a smartphone, a tablet, a server computer, or any other suitable computing device.

The business plan generation device 250 is a device configured to facilitate the automated generation of business plans for a business (e.g., a first business) even in situations in which internal business information for the business is not present. In embodiments, the business plan generation device 250 may be implemented as a computer system such as the computer system 100 illustrated in FIG. 1.

As illustrated in FIG. 2, the business plan generation device 250 includes a storage unit 260 and a memory 270. The storage unit 260 may include a hard disk drive, random access memory (RAM), a read-only memory (ROM), an erasable programmable read-only memory (EPROM or Flash memory), a static random access memory (SRAM), a distributed cloud storage unit, or the like. As illustrated in FIG. 2, the storage unit may be configured to store a business strategy table 261, a target KPIs table 262, a competitor business information table 263, a revised competitor business information table 264, a forecasting data table 265, and an output data table 266. As each of these sets of data will be described in detail later, a description thereof will be omitted here.

The memory 270 may include a random-access semiconductor memory, storage device, or storage medium (either volatile or non-volatile) for storing or encoding data and programs. As illustrated in FIG. 2, the memory 270 may include a set of functional units including a business plan definition unit 272, a business information acquisition unit 274, a forecasting unit 276, and a business plan generation unit 278. Here, each of the business plan definition unit 272, the business information acquisition unit 274, the forecasting unit 276, and the business plan generation unit 278 may be implemented as one or more software modules that form part of a software application (e.g., the business plan generation application 150 illustrated in FIG. 1).

The business plan definition unit 272 is a functional unit configured to define a first business plan for a first business and a set of target business outcomes that indicate desired results of the first business plan. Here, the first business refers to a business associated with a user of the client terminal. The first business may include a for-profit or non-profit enterprise managed by an individual, an organization, or a corporation. As an example, the first business may include a digital services platform for hosting and providing access to digital solutions submitted to the digital services platform by solution owners. However, the first business is not limited herein, and any type of enterprise may be considered as the first business.

The business information acquisition unit 274 is a functional unit configured to acquire a set of business state information that includes at least a set of internal business information that indicates a current state of the first business or a set of competitor business information that indicates a current state of a second business separate from the first business. Here, the “current state” refers to the condition of a business as indicated by its number of products, number of customers, revenue, financial position, or other metrics. The second business (also referred to as a competitor or competing business herein) refers to a business that competes with the first business. For instance, the second business may belong to the same business field (e.g., digital services, pet food production, farming) as the first business.

The forecasting unit 276 is a functional unit configured to identify a first event that is anticipated to impact a particular business field (e.g., the business filed that includes the first and second businesses), and generate, using a statistical analysis technique, a set of forecasting data that includes an impact factor that quantifies an impact of the first event on at least one of the first business or the second business.

The business plan generation unit 278 is a functional unit configured to use a machine learning model to generate, based on the first business plan, the set of target business outcomes, and the set of business state information, a set of output data that includes at least a set of revised business plans for achieving the set of target business outcomes, and output the set of output data to the client terminal 240.

As the business plan definition unit 272, the business information acquisition unit 274, the forecasting unit 276, and the business plan generation unit 278 will be described later, a detailed description thereof will be omitted here.

By means of the business plan generation system 200 illustrated in FIG. 2, it becomes possible to facilitate the automated generation of business plans for a business. Further, by means of the business information acquisition unit 274, it becomes possible to acquire business information for relevant competitors, and to use this competitor business information to generate business plans for a first business even in situations in which internal business information for the first business is not present.

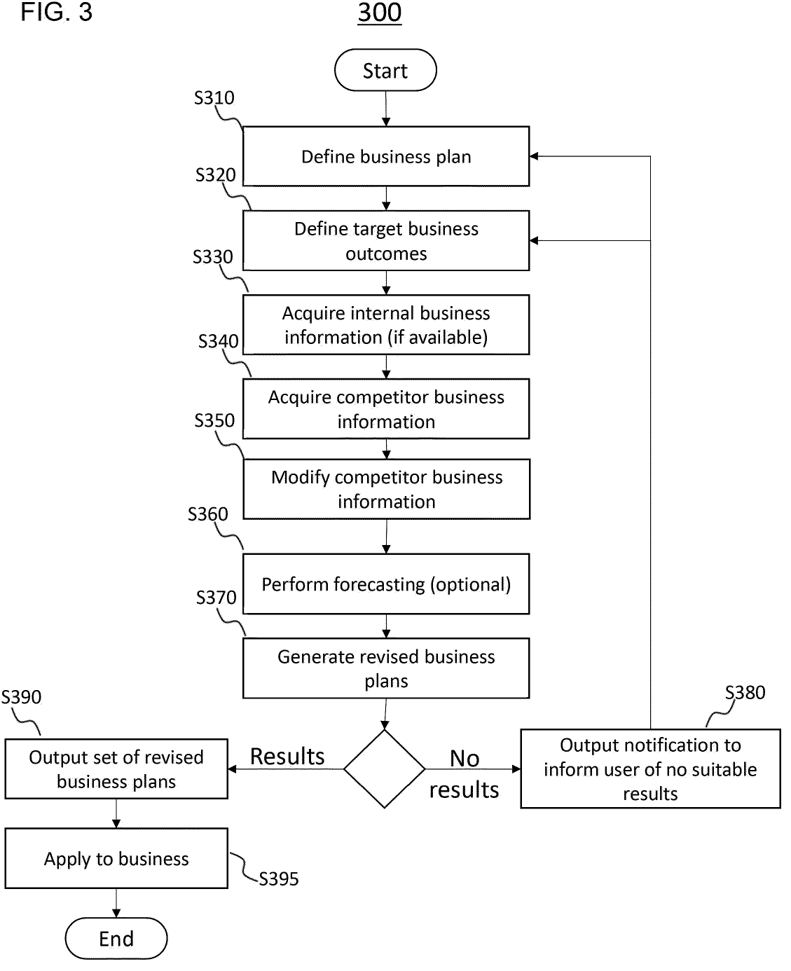

Next, a business plan generation method for generating business plans will be described with respect to FIG. 3.

FIG. 3 is a flowchart illustrating a business plan generation method 300 for generating business plans, according to embodiments of the present disclosure. The business plan generation method 300 illustrates the overall flow of a method of business plan generation, and may be implemented by the various functional units of the business plan generation device (e.g., the business plan generation device 250 illustrated in FIG. 2).

First, at Step S310, the business plan definition unit (for example, the business plan definition unit 272 of the business plan generation device 250 illustrated in FIG. 2) defines a business plan for a first business. Here, a business plan generally refers to a collection of data including a business strategy that characterizes a set of actions to be implemented, a budget that defines an allotment of resources for use in implementing the business strategy, and a set of constraints that define restrictions on implementation of the business strategy. In embodiments, the business plan may be defined by a user (e.g., business manager) who sets a business strategy, a budget, and constraints via a graphical user interface displayed on a client terminal for receiving inputs to the business plan definition unit.

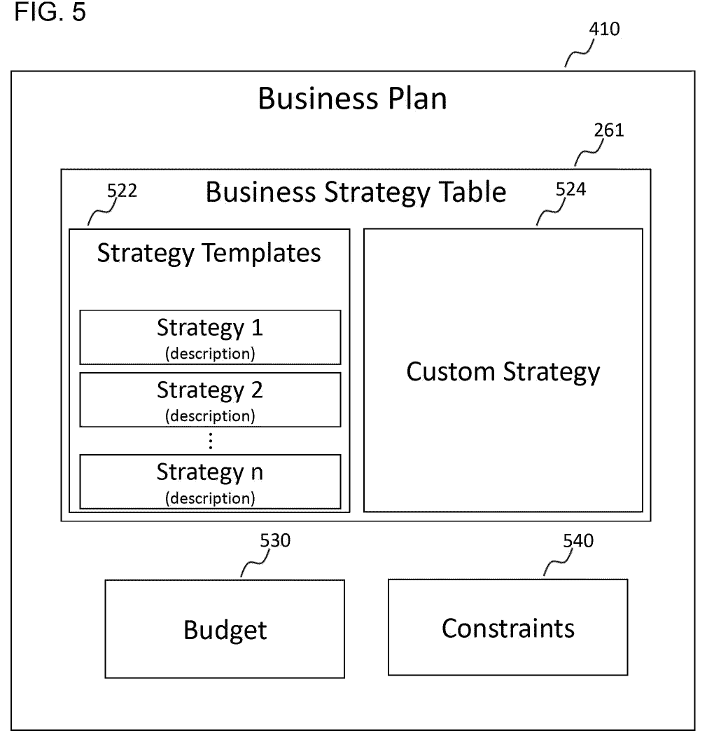

As the details of the business plan according to the present disclosure will be described with reference to FIG. 5, a description thereof will be omitted here.

Next, at Step S320, the business plan definition unit defines a set of target business outcomes. Here, the set of target business outcomes are a collection of data that defines the desired results that the user hopes to achieve by means of the business plan defined in Step S310. As an example, the set of target business outcomes may include a set of target key performance indicators (KPIs) that quantitatively define the desired performance of the business plan with respect to a plurality of business metrics.

As the details of the target business outcomes according to the present disclosure will be described with reference to FIG. 7, a description thereof will be omitted here.

Next, at Step S330, the business information acquisition unit (for example, the business information acquisition unit 274 of the business plan generation device 250 illustrated in FIG. 2) acquires a set of internal business information that indicates a current state of the first business. In embodiments, the business information acquisition unit may utilize an internal business information management unit to collect the set of internal business information from internal storage devices associated with the first business. Here, the set of internal business information may include a number of solutions (for example, products or digital solutions) offered by the first business, a number of clients of the first business, a number of revenue sharing partners, historical business status information, a total amount of revenue for the first business for each of a number of time periods (e.g., years, months, weeks), or the like.

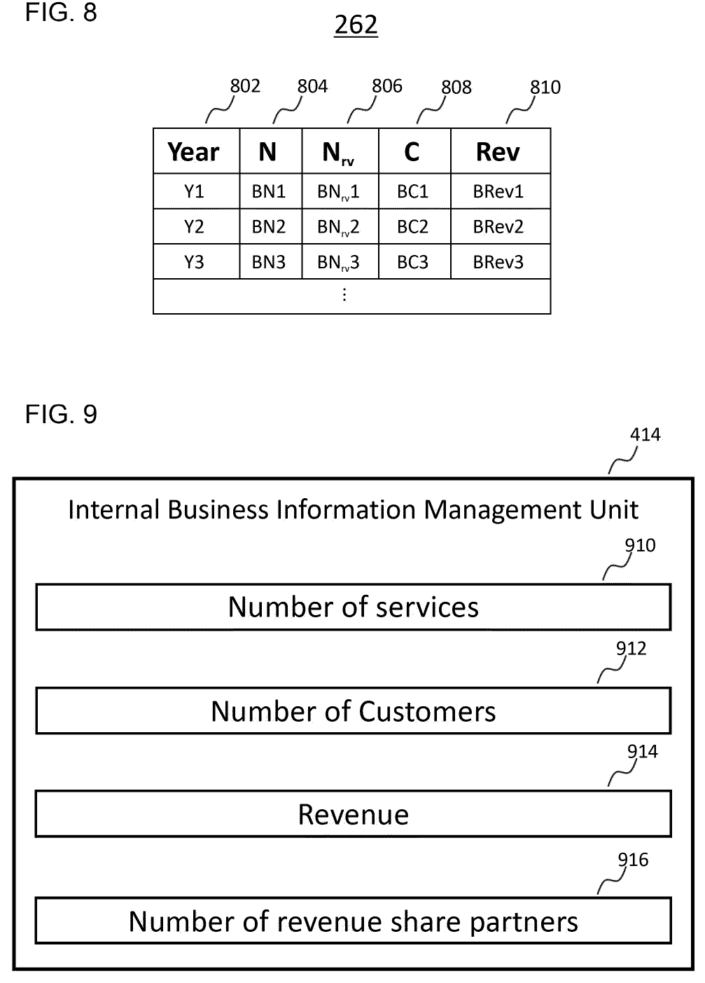

As the details of the internal business information according to the present disclosure will be described with reference to FIG. 8, a description thereof will be omitted here. Additionally, in the case that internal business information for the first business is not present, Step S330 may be skipped.

Next, at Step S340, the business information acquisition unit acquires a set of competitor business information for a second business that differs from the first business (e.g., a competitor of the first business). In embodiments, the business information acquisition unit may utilize a competitor business information management unit configured to send instructions to the data collection server to initiate collection of the set of competitor business information from the external network 210 illustrated in FIG. 2 (e.g., the Internet). Here, the set of competitor business information may include a number of solutions (for example, products or digital solutions) offered by a second business, a number of clients of the second business, a number of revenue sharing partners of the second business, historical business status information for the second business,, business size, business growth, a total amount of revenue for the second business for each of a number of time periods (e.g., years, months, weeks), or the like.

In this way, by collecting competitor business information for a second business in addition to/in place of a set of internal business information for the first business, it is possible to facilitate the automated generation of business plans for a first business even in situations where internal business information for the first business is not present (e.g., due to the first business being recently established or the like).

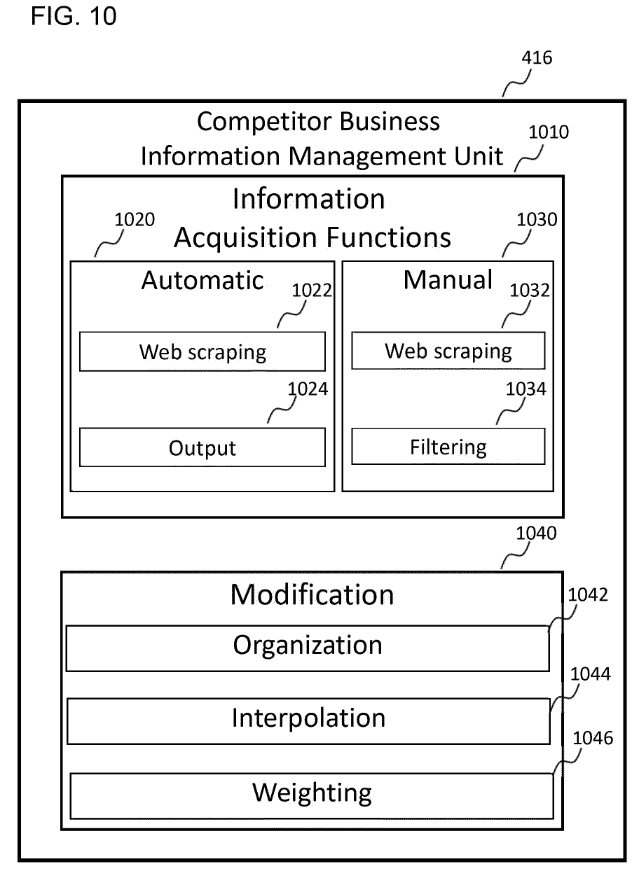

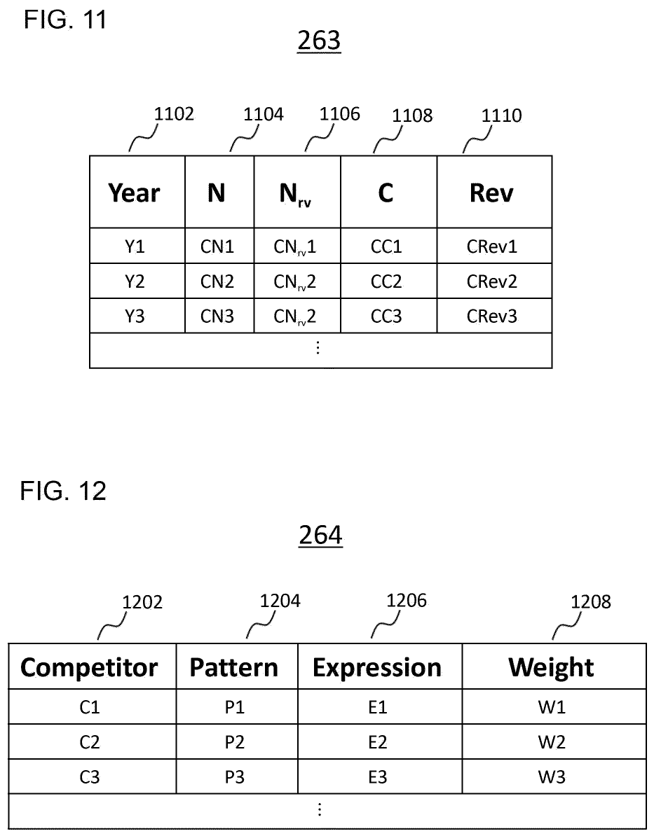

As the details of the competitor business information according to the present disclosure will be described with reference to FIGS. 10-11, a description thereof will be omitted here.

Next, at Step S350, the business information acquisition unit may perform a modification operation with respect to the competitor business information acquired in Step S340. Here, the modification operation may include an interpolation technique to generate predictions for portions of the competitor business information that are missing or incomplete. Additionally, the modification operation may include aggregating, organizing or formatting the competitor business information. In this way, by performing one or more modification operations, competitor business information that is unstructured or partially unavailable may be revised and organized to facilitate the generation of business plans.

As the details of the modification operation according to the present disclosure will be described with reference to FIG. 10, a description thereof will be omitted here.

Next, at Step S360, the forecasting unit (for example, the forecasting unit 276 of the business plan generation device 250 illustrated in FIG. 2) may identify a first event that is anticipated to impact a first business field to which the first business and its competitors belong, and generate, using a statistical analysis technique, a set of forecasting data that includes an impact factor that quantifies an impact of the first event on at least one of the first business or its competitors (e.g., the second business). In embodiments, the first event may be defined by a user via the forecasting unit. In embodiments, the first event may be identified by a machine learning unit configured to detect events that can impact business operations of the first business. Forecasting events that may impact the business field of the first business may facilitate the generation of accurate and reliable business plans.

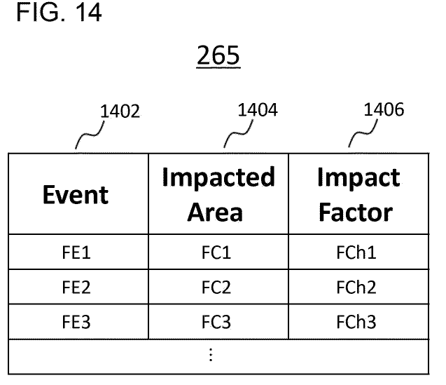

As the details of the forecasting unit according to the present disclosure will be described with reference to FIG. 13, a description thereof will be omitted here. Additionally, this step may be skipped in the case that no events are identified by the machine learning model or defined by the user.

Next, at Step S370, the business plan generation unit (for example, the business plan generation unit 278 of the business plan generation device 250 illustrated in FIG. 2) may generate a set of revised business plans for the first business. Here, the business plan generation unit may use a machine learning model to generate, based on the business plan defined in Step S310, the set of target business outcomes defined in Step S320, and the set of business state information (the set of internal business information acquired in Step S330 and/or the set of competitor business information acquired in Step S340 and modified in Step S350), a set of output data that includes at least a set of revised business plans for achieving the set of target business outcomes.

In the case that the set of revised business plans generated by the business plan generation unit satisfy the set of target business outcomes defined in Step S320, the processing proceeds to Step S390. In the case that the set of revised business plans generated by the business plan generation unit do not satisfy the set of target business outcomes defined in Step S320, the processing proceeds to Step S380.

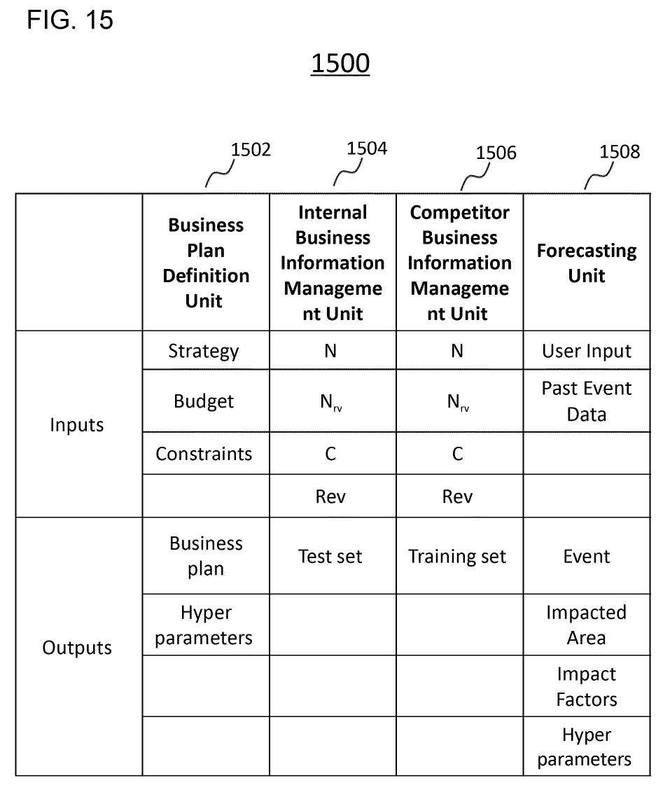

As the details of the business plan generation unit according to the present disclosure will be described with reference to FIG. 15, a description thereof will be omitted here.

In the case that the set of revised business plans generated by the business plan generation unit at Step S370 do not satisfy the set of target business outcomes, at Step S380, the business plan generation unit may output a notification to the user indicating that no suitable business plan results were found, and advising the user to revise the strategy, budget, or constraints of the business plan. Here, the notification may be output to a client terminal (for example, the client terminal 240 illustrated in FIG. 2) to be confirmed by the user.

Subsequently, processing returns to Step S310 to allow for revision of the business plan by the user.

In the case that the set of revised business plans generated by the business plan generation unit at Step S370 satisfy the set of target business outcomes, the business plan generation unit outputs a set of output data that includes at least the set of revised business plans generated in Step S370. Here, the business plan generation unit may output the set of output data to a client terminal (for example, the client terminal 240 illustrated in FIG. 2) to be confirmed, reviewed, and revised by a user.

Next, at Step S395, the set of revised business plans are applied to the business. Here, the user may allocate resources, establish business policies, and contact any number of individuals or businesses to facilitate the implementation of the set of revised business plans with respect to the first business.

By means of the business plan generation method 300 illustrated in FIG. 3, it becomes possible to facilitate the automated generation of business plans for a business. Further, by means of acquiring competitor business information in Step S340, it becomes possible to acquire business information for relevant competitors to the first business, and to use this competitor business information to generate business plans for a business even in situations in which internal business information for the first business is not present.

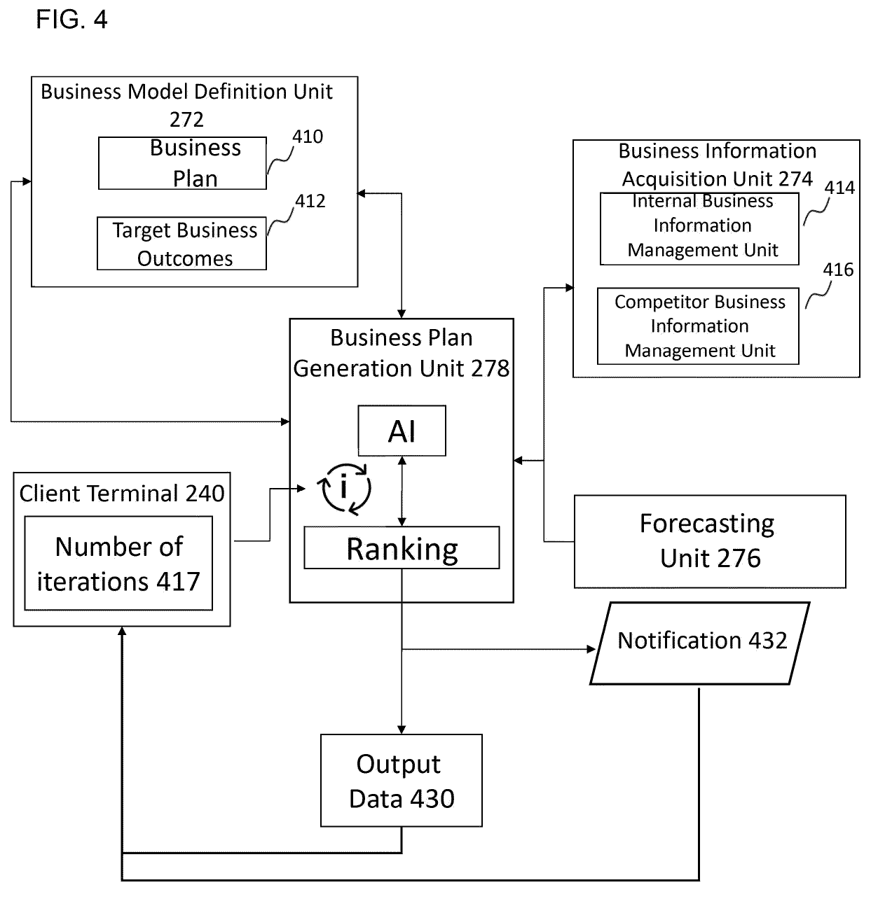

Next, the flow of data within the business plan generation device according to the embodiments of the present disclosure will be described with respect to FIG. 4.

FIG. 4 is a diagram illustrating the flow of data within the business plan generation system 200 according to the embodiments of the present disclosure.

First, the business plan definition unit 272 is used to define a business plan 410 and a set of target business outcomes 412. As described herein, both the business plan 410 and the set of target business outcomes 412 may be defined by a user via a graphical user interface of the business plan definition unit 272 displayed on the client terminal 240.

Next, the business information acquisition unit 274 uses the internal business information management unit 414 and/or the competitor business information management unit 416 to collect a set of internal business information and/or a set of competitor business information.

Next, the forecasting unit 276 is used to identify a first event that is anticipated to impact a first business field to which the first business and its competitors belong, and generate, using a statistical analysis technique, a set of forecasting data that includes an impact factor that quantifies an impact of the first event on at least one of the first business or its competitors.

Next, the client terminal 240 is used to define a number of iterations 417 based on the input of a user. Here, the number of iterations 417 refers to the number of cycles the business plan generation unit 278 should perform when generating the set of revised business plans.

The business plan generation unit 278 receives the business plan 410 and the target business outcomes 412 from the business plan definition unit 272, the internal business information and/or the competitor business information from the business information acquisition unit 274, the set of forecasting data from the forecasting unit 276, and the number of iterations 417 from the client terminal 240. Using these inputs, the business plan generation unit 278 generates a set of revised business plans. In the case that the generated set of revised business plans satisfies the target business outcomes 412, the business plan generation unit 278 outputs a set of output data 430 that includes at least the set of revised business plans to the client terminal 240. In the case that the generated set of revised business plans does not satisfy the target business outcomes 412, the business plan generation unit 278 outputs a notification 432 that indicates to the user that no suitable business plans could be found, and that the constraints should be adjusted.

By means of the business plan generation system 200 illustrated in FIG. 4, it becomes possible to facilitate the automated generation of business plans for a business.

Next, the data configuration of the business plan according to the embodiments of the present disclosure will be described with reference to FIG. 5.

FIG. 5 illustrates the data configuration of the business plan 410 according to the embodiments of the present disclosure. As described herein, the business plan 410 according to the embodiments of the present disclosure refers to a collection of data including a business strategy that characterizes a set of actions to be implemented, a budget that defines an allotment of resources for use in implementing the business strategy, and a set of constraints that define restrictions on implementation of the business strategy. The business plan 410 is defined by a user (e.g., a business manager) via the business plan definition unit. The business plan generation unit uses this user-defined business plan 410 together with other input data (e.g., internal business information and/or competitor business information, set of forecasting data, number of iterations), and uses it to generate a revised business plan that achieves the target business outcomes of the user.

As illustrated in FIG. 5, the business plan 410 primarily includes a business strategy table 261, a budget 530, and constraints 540. The business strategy table 261 is a data table for storing business strategies. Here, a business strategy refers to a sequence of one or more actions to be performed to achieve a business goal. As examples, the business strategy may include securing an investment budget for incentivizing a particular business sector to generate a particular business outcome.

As illustrated in FIG. 5, a business strategy may be defined using one or more pre-defined strategy templates 522 or as a custom strategy 524. The pre-defined strategy templates 522 provide stock, pre-set strategy templates that may be adapted and modified by users for a specific purpose. As an example, in order to accomplish a business goal of generating ideas for new product lines, a strategy template may define a sequence of actions for organizing a competition in which individuals submit ideas for new products, and winners are rewarded with prizes. Other types of pre-defined strategy templates are also possible. The business strategy templates 522 may be suitable for users who are unfamiliar with business strategy creation.

Custom strategies 524 may allow for users to create business strategies from the beginning, and customize every aspect of the strategy. The custom strategies 524 may be suitable for high-level users who wish to have a large degree of control over each aspect of the business strategy.

The budget 530 defines an allotment of resources (e.g., financial resources, personnel resources) for use in implementing the business strategy defined in the business strategy table 261. Here, users may specify a range of the amount of resources ($10,000 to $20,000 dollars) or an upper limit of the amount of resources (up to $20,000 dollars) that can be used for implementing the business strategy.

The constraints 540 define restrictions on implementation of the business plan. As an example, for a business strategy related to maximizing the profit of a farming business, the user may specify a constraint that only crops that grow well in high-humidity environments be considered as candidate crops. Other examples of the constraints 540 are also possible.

In this way, users may use the business plan definition unit to define a business plan 410 in terms of a business strategy that characterizes a set of actions to be implemented, a budget that defines an allotment of resources for use in implementing the business strategy, and a set of constraints that define restrictions on implementation of the business strategy. This business plan 410 can then be used as a reference by the business plan generation unit to generate a revised business plan that achieves the target business outcomes of the user.

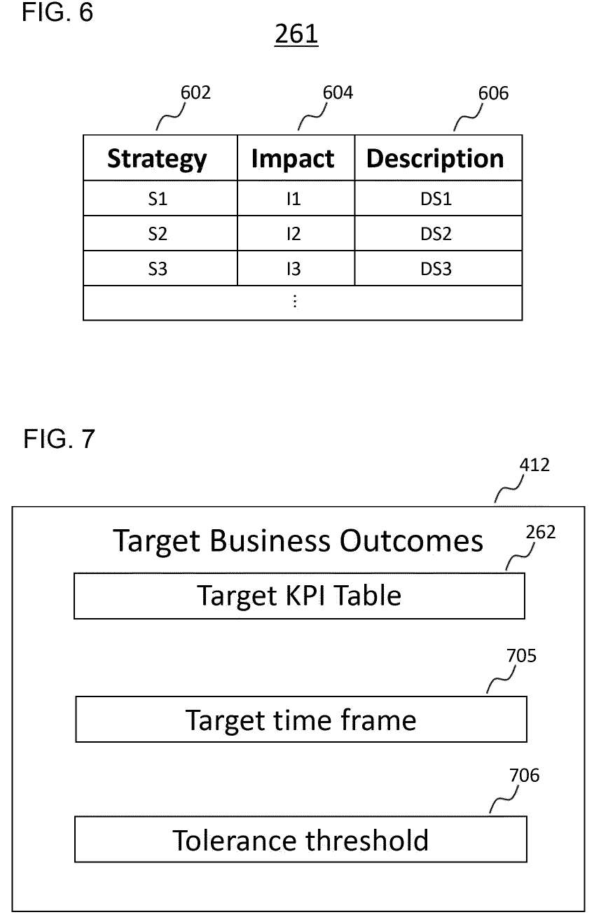

Next, an example of the business strategy table will be described with reference to FIG. 6.

FIG. 6 is a diagram illustrating an example of the business strategy table 261 according to embodiments of the present disclosure. As illustrated in FIG. 6, the business strategy table may include a first column 602, a second column 604, and a third column 606. The first column 602 may list a set of unique identifiers (S1, S2, S3) each corresponding to a different business strategy. The second column 504 may list the impact (I1, I2, I3) that each business strategy is predicted to have on a given business (e.g., 10% increase in revenue, 30% increase in customers). The third column 606 lists a description (DS1, DS2, DS3) of each strategy and associated impact.

Using the business strategy table 261, users may define or select one of a number of business strategies as part of a business plan.

Next, an example of a set of target business outcomes will be described with reference to FIG. 7.

FIG. 7 is a diagram that illustrates an example of a set of target business outcomes 412 according to the embodiments of the present disclosure. As described herein, the set of target business outcomes refer to a collection of data that defines the desired results that a user hopes to achieve by implementing a given business plan. The set of target business outcomes 412 may be defined together with the business plan by a user via the business plan definition unit (for example, the business plan definition unit 272 illustrated in FIG. 2, FIG. 3 and FIG. 4).

As illustrated in FIG. 7, the set of target business outcomes 412 may include a set of target KPIs stored in a target KPIs table 262, a target time frame 705, and a tolerance threshold 706.

The set of target KPIs stored in the target KPIs table 262 are a collection of key performance indicators that indicate a desired degree of performance of the first business with respect to one or more performance metrics. As examples, the set of target KPIs may include parameters related to performance metrics such as business size, business growth, customer growth, return on investment, and the like. For instance, the target KPIs for a digital services platform may include the number of offered solutions/services as an indicator of business size, the annual increase of the number of solutions as an indicator of business growth, the annual increase of the number of subscribers of the platform as an indicator of customer growth, or the like. Accordingly, here, a user may set a target KPI for business growth of “100%,” indicating that the user wishes to double the number of solutions on the platform after applying the business plan.

The target time frame 705 specifies a desired time period for achieving the set of target KPIs. As an example, a user may specify a target time frame of “1 year” in which to achieve the set of target KPIs of the target KPIs table 262.

The tolerance threshold 706 defines a permissible range of variation of the set of target key performance indicators or the target time frame 705. The tolerance threshold 706 may be defined in terms of a percentage, or in terms of the specific units of the quantity to which it applies. For instance, the tolerance threshold 706 may be set as “ ± 10%,” “± 2 months” or the like. Setting a tolerance threshold 706 provides greater flexibility for generating business plans that achieve the set of target KPIs. As examples, the business plan generation unit may recommend a business strategy that achieves 96% business growth (instead of the 100% specified by the user), or it might recommend a business strategy that achieves 100% business growth within 1.2 years (instead of the 1 year specified by the user). In these cases, if the margin of error of the recommended business strategies is lower than specified tolerance threshold 706, these business strategies can be considered as viable options for a business plan.

In this way, users may use the business plan definition unit to define target business outcomes 412 for a business plan. These target business outcomes 412 can then be used as a reference by the business plan generation unit together with the business plan to generate a revised business plan that achieves the target business outcomes 412.

Next, an example of the set of target KPIs according to the embodiments of the present disclosure will be described with reference to FIG. 8.

FIG. 8 is a diagram illustrating an example of a target KPIs table 262 according to embodiments of the present disclosure. As described herein, the target KPIs table 262 is a data table configured to store information related to a set of target KPIs defined by the user. As illustrated in FIG. 8, the target KPI table 262 may include a first column 802 that indicates a particular year, a second column 804 that indicates a target number of solutions for the corresponding year, a third column 806 that indicates the number of solutions associated with revenue sharing (e.g., revenue sharing between solution owners and platform managers), a fourth column 808 indicating a target number of customers, and a fifth column 810 indicating a target revenue value.

Using the target KPI table 262, users may define a set of target KPIs that indicate the desired performance of a business plan.

Next, an example of the internal business information management unit according to the embodiments of the present disclosure will be described with reference to FIG. 9.

FIG. 9 is a diagram illustrating an example configuration of the internal business information management unit 414 according to the embodiments of the present disclosure. The internal business information management unit 414 may be used to collect internal business information for the first business (that is, the business for which the user wishes to generate a business plan).

As illustrated in FIG. 9, the internal business information management unit 414 includes a number of information collection functions 910-916 for acquiring internal business information. Each of these information collection functions 910-916 may be configured to acquire a different type of internal business information. In embodiments, the information collection functions 910-916 may be displayed as part of a graphical user interface on the client terminal, and prompt a user to define the internal business information. In embodiments, the information collection functions 910-916 may be configured to automatically search a pre-designated internal database or storage repository to retrieve the internal business information.

More particularly, the information collection functions may include a number of services collection function 910, a number of customers collection function 912, a revenue collection function 914, and a number of revenue sharing partners collection function 916.

The number of services collection function 910 is a data collection function configured to collect information about the number of services (digital solutions, products) offered by the first business.

The number of customers collection function 912 is a data collection function configured to collection information about the number of customers of the first business.

The revenue collection function 914 is a data collection function configured to collect information about the total revenue of the first business.

The number of revenue sharing partners collection function 916 is a data collection function configured to collect information about the number of revenue sharing partners of the first business.

Using the information collection functions 910-916, internal business information such as the number of services, number of customers, total revenue, and number of revenue sharing partners can be collected for the first business. This internal business information can be used together with the business plan defined by the user as a basis to generate a set of revised business plans for the first business.

Next, an example of the competitor business information management unit according to the embodiments of the present disclosure will be described with reference to FIG. 10.

Aspects of the disclosure relate to the recognition that, in some circumstances, such as in the case of a recently established business, internal business data for a business (e.g., a first business) may not be available. In such cases, it may be difficult to develop reliable business plans for the first business. Accordingly, aspects of the disclosure relate to collecting a set of competitor business information for a second business (e.g., a competing business that belongs to the same business field as the first business), and using this set of competitor business information together with or in place of the internal business information for the first business to facilitate the generation of business plans for the first business.

FIG. 10 is a diagram illustrating an example configuration of the competitor business information management unit 416 according to the embodiments of the present disclosure. The competitor business information management unit 416 may be used to collect a set of competitor business information for a second business, and perform modification of the collected set of competitor business information to organize, interpolate, and weight the set of competitor business information in order to generate a revised set of competitor business information.

As illustrated in FIG. 10, the competitor business information management unit 416 primarily includes a set of information acquisition functions 1010 and a set of modification functions 1040. The set of information acquisition functions 1010 provide functionality for acquiring the set of competitor business information. More particularly, the set of information acquisition functions 1010 may include an automatic data collection function 1020 for automated collection of the set of competitor business information and a manual data collection function 1030 for user-assisted collection of the set of competitor business information.

The automatic data collection function 1020 includes a web scraping tool 1022 and an output function 1024. The web scraping tool 1022 may include an API configured to search an external network (e.g., the Internet) to recognize unique HTML site structures, extract and transform content, temporarily store scraped data, extract data from databases and APIs, and perform other necessary functions to acquire competitor business information from the external network. More specifically, the web scraping tool 1022 may use a search engine together with a natural language processing technique to search for and identify businesses that may be potential competitors to the first business (e.g., businesses that belong to the same business field, businesses that offer similar products or services to the first business), and subsequently collect information about the current state of these identified businesses (e.g., number of services, number of customers, amount of revenue) as the set of competitor business information. The collected set of competitor business information may be presented to the user in a graphical user interface (see FIG. 19) via the output function 1024.

The manual data collection function 1030 provides tools for users to supplement and revise the set of competitor business information collected by the automatic data collection function 1020.

More particularly, a user may use the web scraping tool 1032 to manually navigate to a relevant web page, external database, or other data source, and designate the content of this web page, external database, or other data source as competitor business information. As an example, in a case that the set of competitor business information collected by the web scraping tool 1022 and output via the output function 1024 does not include a relevant competing business, or particular information regarding this competing business, the user may use the web scraping tool 1032 to manually designate the competing business or the information about the competing business.

Further, the user may use the filtering function 1034 to exclude or remove data that should not be included as the set of competitor business information. For example, the user may confirm the set of competitor business information collected by the web scraping tool 1022 and output via the output function 1024, and exclude information about businesses that are not considered to be competitors to the first business, or business information that is not relevant for the creation of a business plan.

The modification functions 1040 provide functionality for organizing, interpolating, and weighting the set of competitor business information. The modification functions 1040 may be used to process the set of competitor business information acquired by the information acquisition functions 1010 to generate a set of revised competitor business information. This set of revised competitor business information may be used in the generation of revised business plans by the business plan generation unit, as described later.

As illustrated in FIG. 10, the modification functions may include an organization function 1042, an interpolation function 1044, and a weighting function 1046.

The organization function 1042 provides functionality for organizing the set of competitor business information acquired via the information acquisition functions 1010. For example, the organization function 1042 may include an aggregation function for grouping together competitor business information for multiple competing businesses in a single data table. As an additional example, the organization function 1042 may include natural language processing tools to parse and analyze unstructured textual data included in the set of competitor business information to derive insights about competing businesses, and database construction algorithms to represent the derived insights as database tables. Other types of organization functions are also possible.

The interpolation function 1044 provides functionality for supplementing the set of competitor business information to fill in missing or incomplete portions. The interpolation function 1044 may be performed by using one or more statistical techniques to curve-fit the available data based on an identified time evolution pattern such as linear growth, exponential growth, bounded growth, saturation, or the like, and generate a set of predicted data to supplement missing or incomplete portions of the set of competitor business information. Here, the interpolation function 1044 may include piecewise constant interpolation techniques, linear interpolation techniques, polynomial interpolation techniques, spline interpolation techniques, Gaussian-based interpolation techniques or the like.

As an example, in the case that information regarding the number of services offered by a competing business is available for 2016, 2017, 2019, and 2020, but missing for 2018, the interpolation function 1044 may use one of the aforementioned techniques to estimate the number of services offered by the competing business in 2018.

The weighting function 1046 provides functionality for assigning a weighting value to each business identified as a potential competitor based on the collected competitor business information. The weighting value refers to a quantitative measure of the relative importance or relevance, or impact of a competing business on the first business. In embodiments, the weighting value may be expressed as an integer value between 0 and 10, where lower values indicate lower relevance, and higher values indicate higher relevance. Here, the weighting function 1046 may include a machine learning technique trained to evaluate the overall similarity between the first business and each of the identified competing businesses based on business field, target customer demographics, products and services, size, and the like, and assign a weighting value based on the determined overall similarity (e.g., businesses with greater similarity to the first business are allocated greater weighting values). In embodiments, the weighting value may be assigned or revised by a user.

Using the competitor business information management unit 416, business information for competitors of the first business may be collected and revised. By using this revised competitor business information in addition to/in place of a set of internal business information, it is possible to facilitate the automated generation of business plans for a first business even in situations where internal business information for the first business is not present (e.g., due to the first business being recently established or the like).

Next, an example of the set of competitor business information according to the embodiments of the present disclosure will be described with reference to FIG. 11.

FIG. 11 is a diagram illustrating an example of a competitor business information table 263 according to embodiments of the present disclosure. As described herein, the competitor business information table 263 is a data table configured to store a set of competitor business information collected by the competitor business information management unit (e.g., the competitor business information management unit 416 illustrated in FIG. 3 and FIG. 10).

It should be noted that, while the competitor business information table 263 illustrates a set of competitor business information collected for one competing business (e.g., a second business) for convenience of explanation, the competitor business information table 263 is not limited to this configuration, and may store competitor business information for a plurality of competing businesses.

As illustrated in FIG. 11, the competitor business information table 263 may include a first column 1102 that indicates a particular year, a second column 1104 that indicates a target number of solutions offered by a competing business for the corresponding year, a third column 1106 that indicates the number of solutions of the competing business associated with revenue sharing (e.g., revenue sharing between solution owners and platform managers), a fourth column 1108 indicating the number of customers of the competing business, and a fifth column 1110 indicating a revenue value of the competing business for the corresponding year.

By means of the competitor business information table 263, competitor business information collected using the competitor business information unit may be formatted as a structured data table.

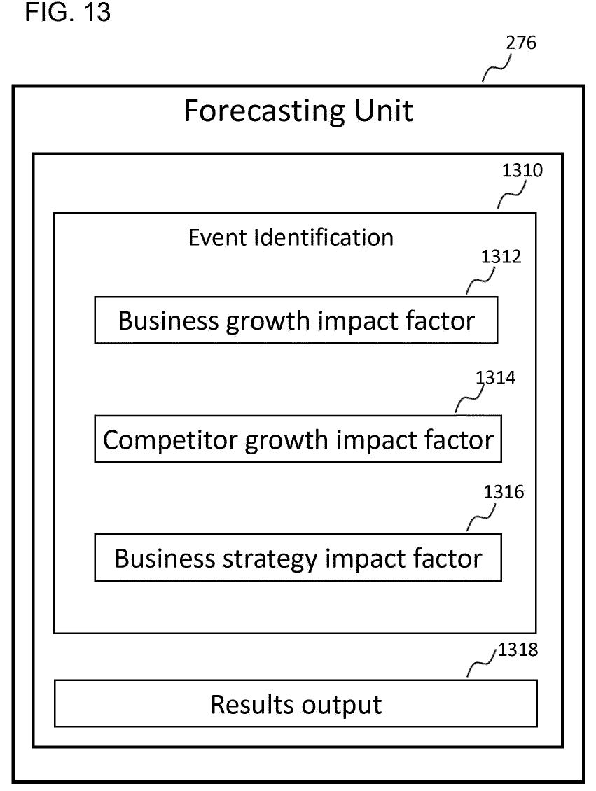

Next, an example of the revised set of competitor business information according to the embodiments of the present disclosure will be described with reference to FIG. 12.

FIG. 12 is a diagram illustrating an example of a revised competitor business information table 264 according to embodiments of the present disclosure. As described herein, the revised competitor business information table 264 is a data table configured to store a set of revised competitor business information generated by performing one or more modification operations on the set of competitor business information.

For instance, the revised competitor business information stored in the revised competitor business information table 264 may be generated by performing modification operations to aggregate competitor business information for a plurality of competing businesses into a single data table, curve-fitting a growth pattern of the competitor business information and performing interpolation, and assigning weights to each competing business.

As illustrated in FIG. 12, the revised competitor business information table 264 may include a first column 1202 that stores information identifying competing businesses (C1, C2, C3), a second column 1204 that lists the type of growth pattern (e.g., linear, exponential) exhibited by a particular competing business with respect to a particular metric (e.g., number of services, number of customers, revenue), a third column 1206 that lists the mathematical expression (f(x)=b+mx) of the corresponding growth pattern listed in 1204, and a fourth column 1208 that lists the weighting value determined for the corresponding competing business.

By means of the revised competitor business information table 264, insights derived from the collected set of competitor business information may be formatted as a structured data table. As will be described later, the revised competitor business information stored in the revised competitor business information table 264 may be used to facilitate generation of business plans for a first business. In this way, business plans can be generated even in situations in which internal business information is not present.

Next, an example of the forecasting unit according to the embodiments of the present disclosure will be described with reference to FIG. 13.

FIG. 13 is a diagram illustrating an example configuration of the forecasting unit 276 according to the embodiments of the present disclosure. As described herein, the forecasting unit 276 is a functional unit configured to identify a first event that is anticipated to impact a first business field to which the first business and its competitors belong, and generate, using a statistical analysis technique, a set of forecasting data that includes an impact factor that quantifies an impact of the first event on at least one of the first business or its competitors.

As illustrated in FIG. 13, the forecasting unit 276 may include an event identification function 1310 and a results output function 1318.

In embodiments, the event identification function 1310 may include a machine learning unit trained to predict the occurrence of future events that may impact the first business and quantify the degree of impact based on past event data. The impact of the first event may be represented in the form of an impact factor. Here, an impact factor refers to a quantitative measure of the predicted impact and may be expressed as a percentage or as an integer value between 0 and 10, where lower values indicate lesser impact and greater values indicate greater impact.

In embodiments, impact factors may be calculated to indicate the impact of the first event on a variety of targets. For instance, as illustrated in FIG. 13, the event identification function 1310 may determine a business growth impact factor 1312 to indicate the impact of the first event on the growth of the first business, a competitor growth impact factor to indicate the impact of the first event on the growth of one or more competing businesses, and a business strategy impact factor to indicate the impact of the first event on a variety of business strategies. A set of forecasting data that indicates the identified first event, the impacted business area, and the determined impact factor (e.g., the business growth impact factor 1312, competitor growth impactor factor 1314, and/or the business strategy impact factor 1316) may be output to a graphical user interface (see FIG. 19) by the results output function 1318.

As an example, the event identification function 1310 may identify a first event of “drought” based on available weather forecast information, and predict the anticipated impact of the drought on the growth of a first business related to coffee production, the anticipated impact of the drought on competitors of the first business, and the anticipated impact of the drought on various types of business strategies.

In certain embodiments, the event identification function 1310 may be configured to receive an input for designating the first event, the business growth impact factor 1312, the competitor growth impact factor 1314, and the business strategy impact factor 1316 from a user. Identifying the first event and the impact factors based on a user input may be desirable in situations in which events are anticipated/occurring for which historical data to train a machine learning model is not available.

As an example, for a first business of a digital services platform, a user may specify a first event of “global pandemic.” In a global pandemic scenario, as demand for services to support work-from-home and operation automation are likely to increase, the growth of the first business and its competitors are likely to be positively impacted. Accordingly, the user may specify business growth impact factors 1312 and competitor growth impact factors 1314 that represent the anticipated positive growth resulting from this first event. Further, in a global pandemic scenario, business strategies that are based on digital marketing are likely to be more effective, as more people remain home and rely on digital communications. Accordingly, the user may specify a business strategy impact factor 1316 to indicate the anticipated positive effect of business strategies based on digital marketing.

By means of the forecasting unit 276, events that are anticipated to impact the first business and its competitors can be identified, and impact factors for quantitatively indicating the impact of the identified events can be generated. These impact factors can be used as inputs to the business plan generation unit to facilitate the generation of business plans that take into account ongoing/future events.

Next, an example of a set of forecasting data according to embodiments of the present disclosure will be described with reference to FIG. 14.

FIG. 14 is a diagram illustrating an example of a forecasting data table 265 according to embodiments of the present disclosure. As described herein, the set of forecasting data table 265 is a collection of data generated by the forecasting unit (e.g., the forecasting unit 276 illustrated in FIG. 2, FIG. 4, and FIG. 13), and, as illustrated in FIG. 14, may include a first column 1402 that lists the events (e.g., first event) identified by the forecasting unit, a second column 1404 that indicates the area of business impacted by the event (e.g., communications, service development, marketing, overall growth), and a third column 1406 that indicates the impact factor (e.g., the business growth impact factor, competitor growth impactor factor, and/or the business strategy impact factor) determined based on the identified event.

By means of the forecasting data table 265, the data generated by the forecasting unit may be formatted as a structured data table. As will be described later, the forecasting data stored in the forecasting data table 265 may be used to facilitate generation of business plans for a first business. In this way, business plans can be generated that take into account events that may impact business operations of the first business.

Next, the input and output data of each functional unit of the business plan generation device according to the embodiments of the present disclosure will be described with respect to FIG. 15.

As described herein, each of the business plan definition unit, the internal business information management unit, the competitor business information management unit, and the forecasting unit described herein are configured to receive a set of input data and perform various processing operations to generate a set of output data. FIG. 15 is a diagram illustrating an input/output data table 1500 that illustrates the input and output data of each functional unit of the business plan generation device according to the embodiments of the present disclosure.

As illustrated in FIG. 15, the input/output data table 1500 includes a first column 1502 listing the input data and output data of the business plan definition unit, a second column 1504 listing the input data and output data of the internal business information management unit, a third column 1506 listing the input data and output data of the competitor business information management unit, and a fourth column 1508 listing the input data and output data of the forecasting unit.

As illustrated in the first column 1502, the business plan definition unit is configured to receive input data including a business strategy, a budget and constraints. These inputs may be received from a user via a graphical user interface. Additionally, the business plan definition unit may use these inputs to define a business plan. This user-defined business plan may be used together with other input data to generate a revised business plan that achieves the target business outcomes of the user. Further, the business plan definition unit may output a set of hyper parameters used to configure the machine learning model used by the business plan generation unit. These hyperparameters may be derived based on the business plan.

As illustrated in the second column 1504, the internal business information management unit is configured to collect, as inputs, a number of solutions (for example, products or digital solutions) offered by the first business, a number of revenue sharing partners of the first business, a number of clients of the first business, a total amount of revenue for the first business for each of a number of time periods (e.g., years, months, weeks), or the like. Further, in embodiments, the internal business information management unit may use these inputs to generate a set of test data as an output. This set of test data is a collection of data used to evaluate the performance of the machine learning model used by the business plan generation unit.

As illustrated in the third column 1506, the competitor business information unit 1506 is configured to collect, as inputs, a number of solutions (for example, products or digital solutions) offered by a second business (a competitor of the first business), a number of revenue sharing partners of the second business, a number of clients of the second business, a total amount of revenue for the second business for each of a number of time periods (e.g., years, months, weeks), or the like. Further, in embodiments, the competitor business information management unit may use these inputs to generate a set of training data. This set of training data is a collection of data used to train the machine learning model used by the business plan generation unit.

As illustrated in the fourth column 1508, the forecasting unit is configured to receive, as inputs, either a user input defining a first event or past event data that may be used to predict the occurrence and impact of a first event on the first business. The forecasting unit may use the user input or the past event data to predict one or more events (e.g., a first event),the area of business anticipated to be impacted by the event (e.g., communications, service development, marketing, overall growth), and one or more impact factors (e.g., the business growth impact factor, competitor growth impactor factor, and/or the business strategy impact factor) that quantitatively indicate the impact of the identified events on the first business. Further, in embodiments, the forecasting unit may output a set of hyper parameters used to configure the machine learning model used by the business plan generation unit. These hyperparameters may be derived based on the set of forecasting data.

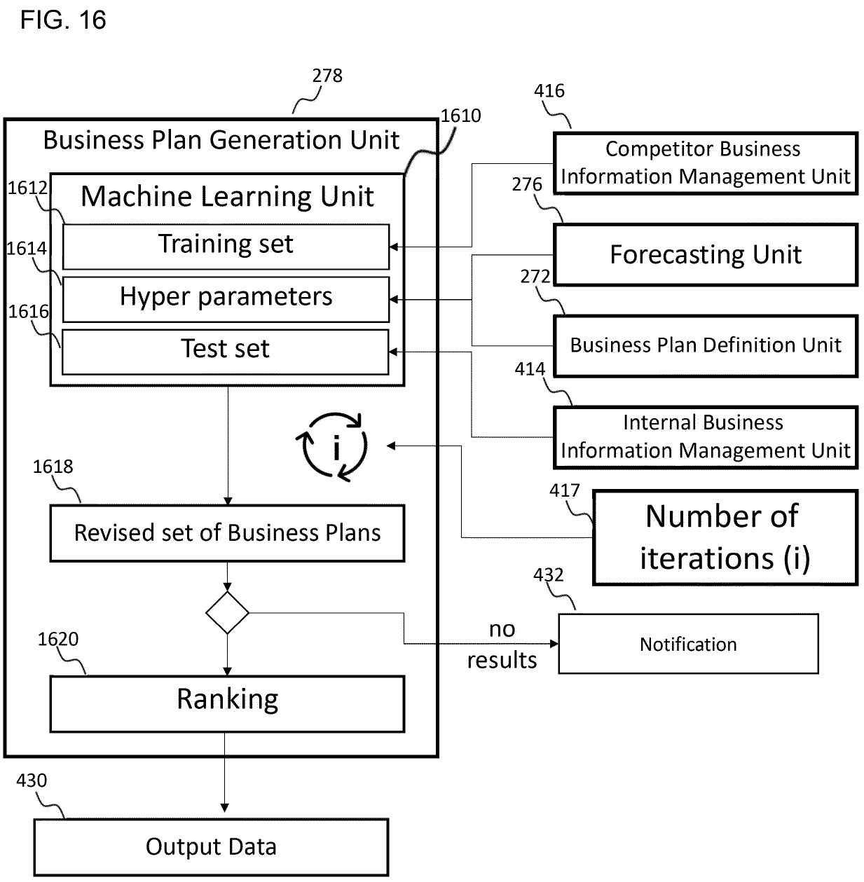

Next, an example of the business plan generation unit according to the embodiments of the present disclosure will be described with reference to FIG. 16.

FIG. 16 is a diagram illustrating an example configuration of the business plan generation unit 278 according to the embodiments of the present disclosure. As described herein, the business plan generation unit is a functional unit configured to use a machine learning model to generate a set of output data that includes at least a set of revised business plans for achieving the set of target business outcomes and output the set of output data.

As illustrated in FIG. 16, the business plan generation unit 278 is configured to receive data from the competitor business information management unit 416, the forecasting unit 276, the business plan definition unit 272, and the internal business information management unit 414, and input the received data to a machine learning unit 1610. Here, the machine learning unit 1610 may include, for instance, a neural network such as an artificial neural network, a convolutional neural network, a recurrent neural network, or other artificial intelligence technique configured to generate revised business plans based on input data.

More particularly, in a training phase, the machine learning unit 1610 may be trained using a training set 1612 output by the competitor business management unit 416. As described herein, the training set 1612 is generated by the competitor business management unit 416 based on the collected set of competitor business information. Here, the machine learning unit 1610 may be trained to generate revised business plans based on the training set 1612. By training the machine learning unit 1610 using a training set 1612 generated based on competitor business information, it is possible to construct a trained machine learning unit for developing revised business plans even in cases in which internal business information for a first business is not available. The machine learning unit 1610 may continue to be trained using the training set 1612 until a desired level of accuracy is achieved.

Further, in the training phase, the machine learning unit 1610 may be configured by a set of hyperparameters 1614 generated by both the forecasting unit 276 and the business plan definition unit 272. This set of hyperparameters 1614 may function to cause the machine learning unit 1610 to generate revised business plans that take into account the business plan and the target business outcomes defined by the user via the business plan definition unit 272 and the forecasting data predicted by the forecasting unit 276.

Upon completion of the training phase, a test set 1616 generated by the internal business information management unit 414 may be input to the trained machine learning unit 1610. The test set 1616 is a collection of data generated based on the internal business data of the first business. It should be noted that, in situations in which internal business data for the first business is not available, the test set 1616 may be a placeholder data set. The trained machine learning unit 1610 may utilize this test set 1616 to generate a revised set of business plans 1618.

Here, the set of revised set of business plans 1618 include a collection of business plans that alter, change, edit, or otherwise modify the business plan defined by the user via the business plan definition unit 272 to accomplish the set of target business outcomes in a more efficient manner (e.g., faster, using less resources, achieving greater performance). More particularly, each of the set of revised business plans specify a business strategy (e.g., a second business strategy) that characterizes a set of actions to be implemented as part of the revised business plan, a budget (e.g., a second budget) that defines an allotment of resources necessary for implementing the revised business plan, a set of target KPIs (second set of target KPIs) that indicate a predicted degree of performance of the first business with respect to one or more performance metrics, and a confidence level that indicates an accuracy of the revised business plan.

Here, the trained machine learning unit 1610 may repeat the business plan generation process for a number of iterations designated by the number of iterations 417 defined by the user. Performing a greater number of iterations may allow the machine learning unit 1610 to generate a greater number of revised business plans.

In the case that the generated set of revised business plans 1618 satisfies the target business outcomes defined by the user (e.g., within the tolerance threshold), the business plan generation unit 278 uses a ranking function 1620 to rank each of the set of revised business plans 1618 based on how well they achieve the target business outcomes defined by the user, and subsequently output a set of output data 430 that includes the ranked set of revised business plans. Here, the set of output data 430 may be output via a graphical user interface (see FIG. 19) of the client terminal.

In the case that the generated set of revised business plans do not satisfy the target business outcomes defined by the user, the business plan generation unit 278 outputs a notification 432 that indicates to the user via a graphical user interface (see FIG. 19) of the client terminal that no suitable business plans could be found, and that the constraints should be adjusted.

By means of the business plan generation unit 278, it becomes possible to automatically generate business plans that achieve user-defined target business objectives even in cases in which internal business data for a first business is not available.

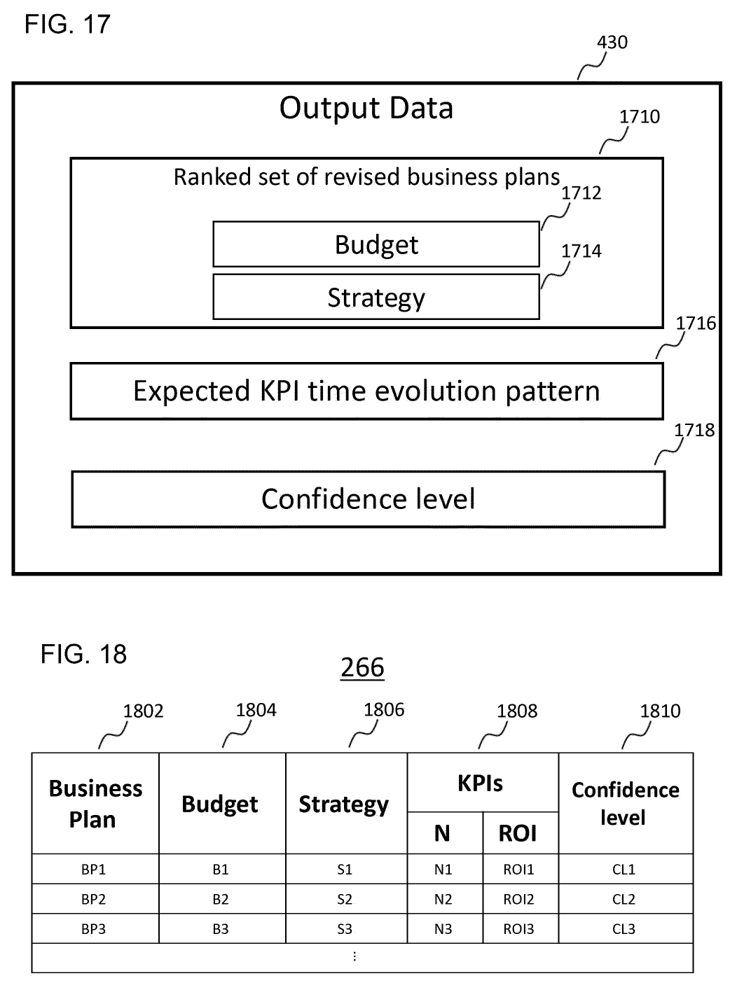

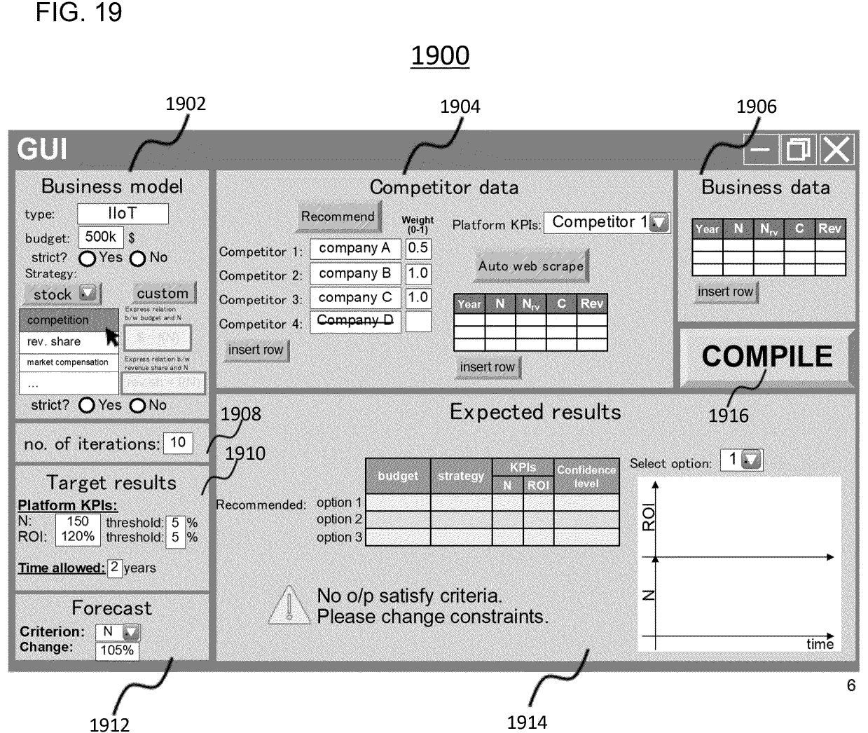

Next, an example of the set of output data according to the embodiments of the present disclosure will be described with reference to FIG. 17 and FIG. 18.

FIG. 17 is a diagram illustrating the logical configuration of the data elements included in the set of output data 430 according to the embodiments of the present disclosure. As illustrated in FIG. 17, the set of output data 430 primarily includes a ranked set of revised business plans characterized by a budget 1712 and a strategy 1714, an expected KPI time evolution pattern 1716, and a confidence level 1718.

The ranked set of revised business plans 1710 refer to a collection of business plans that alter, change, edit, or otherwise modify the business plan defined by the user via the business plan definition unit 272 and ranked according to the degree to which they accomplish the set of target business outcomes. Each of these revised business plans may be associated with a strategy 1714 that characterizes a set of actions to be implemented as part of the business plan, and a budget 1712 that defines an allotment of resources for use in implementing the business strategy 1714.

The expected KPI time evolution pattern 1716 illustrates how the KPIs of each of the revised business plans are expected to evolve over time. In embodiments, the expected time evolution pattern 1716 may be represented in the form of a graph that indicates the predicted evolution of one or more KPI metrics over a defined time period.

The confidence level 1718 indicates the degree of reliability of each revised business plan. In embodiments, the confidence level 1718 may be expressed in the form of a percentage, where a greater percentage indicates a greater degree of reliability, and a lesser percentage indicates a lesser degree of reliability. The confidence level 1718 may be calculated based on the quality, amount, and robustness of the internal business information and the competitor business information using a pre-existing confidence level algorithm.

FIG. 18 is a diagram illustrating an output data table 266 according to the embodiments of the present disclosure. The output data table 266 is a data table configured to store the set of output data generated by the business plan generation unit. As illustrated in FIG. 18, the output data table 266 includes a first column 1802 for storing a set of business plan identifiers for identifying a particular revised business plan, a second column 1804 for storing budget information for a corresponding revised business plan, a third column 1806 for storing the business strategy of a corresponding revised business plan, a fourth column 1808 for storing KPIs (e.g., number of solutions, return on interest) of a corresponding revised business plan, and a fifth column 1810 for storing a confidence level of a corresponding revised business plan.

As illustrated with reference to the above-described FIG. 17 and FIG. 18, a set of output data that defines the features of the revised business plans generated by the business plan generation unit can be created and output to a graphical user interface (see FIG. 19) of the client terminal for confirmation, review, and implementation by a user.

Next, a graphical user interface according to the embodiments of the present disclosure will be described with reference to FIG. 19.

FIG. 19 illustrates a graphical user interface 1900 according to the embodiments of the present disclosure. The graphical user interface 1900 may be displayed on a client terminal (for example, the client terminal 240 illustrated in FIG. 2). The graphical user interface 1900 may be used to display various information to a user and receive user inputs.

As illustrated in FIG. 19, the graphical user interface 1900 may include a business plan definition window 1902, a competitor business information window 1904, an internal business information window 1906, an iteration management window 1908, a target business outcome window 1910, a forecasting window 1912, an output data window 1914, and a compile button 1916.

The business plan definition window 1902 provides an interface for a user to define a business plan in terms of a type of business plan (e.g., industrial internet of things, digital services), a budget, a strategy, and a tolerance threshold.

The competitor business information window 1904 provides an interface for a user to initiate automated collection of the competitor business information via web-scraping, and filter and revise the collected competitor business information as necessary.

The internal business information window 1906 provides an interface for a user to manually insert internal business information for a first business or initiate a search of a pre-designated internal database or storage repository to retrieve the internal business information.

The iteration management window 1908 provides an interface for a user to designate the number of iterations to be performed by the business plan generation unit.

The target business outcome window 1910 provides an interface for a user to define a set of target business outcomes in terms of a set of target KPIs, a target time frame, and a tolerance threshold.

The forecasting window 1912 provides an interface for a user to define a business area criterion anticipated to be affected by a particular event, as well as the change (impact factor) that the particular event is predicted to have on the business area criterion.

The output data window 1914 provides an interface for a user to confirm and review the set of output data generated by the business plan generation unit. Here, a user may view the ranked set of revised business plans, as well as the expected KPI time evolution pattern associated with each revised business plan. Alternatively, in the event that no business plans that achieve the target business outcomes specified by the user are generated, a notification prompting the user to adjust the constraints of the business plan may be displayed.

The compile button 1916 allows the user to initiate automated generation of the set of revised business plans using the input information designated in the business plan definition window 1902, the competitor business information window 1904, the internal business information window 1906, the iteration management window 1908, the target business outcome window 1910, the forecasting window 1912, and the output data window 1914.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced.

These embodiments were described in sufficient detail to enable those skilled in the art to practice the embodiments, but other embodiments may be used, and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

### Reference Signs List

100... Computer system
102... Processor
104... Memory
106... Memory bus
108... I/O bus
109... Bus IF
110... I/O Bus IF
112... Terminal interface
113... Storage interface
114... I/O device interface
115... Network interface
116... User I/O device
117... Storage device
124... Display system
126... Display
130... Network
150... Business plan generation application
200... Business plan generation system
210... External network
220... Data collection server
230... Internal network
240... Client terminal
250... Business plan generation device
260... Storage unit
261... Business strategy table
262... Target KPIs table
263... Competitor business information table
264... Revised competitor business information table
265... Forecasting data table
266... Output data table
270... Memory
272... Business plan definition unit
274... Business information acquisition unit
276... Forecasting unit
278... Business plan generation unit

What is claimed is:

1. A business plan generation device comprising:
a business plan definition unit configured to define a first business plan for a first business and a set of target business outcomes that indicate desired results of the first business plan;
a business information acquisition unit configured to acquire a set of business state information that includes at least a set of internal business information that indicates a current state of the first business or a set of competitor business information that indicates a current state of a second business separate from the first business; and
a business plan generation unit configured to use a machine learning model to generate, based on the first business plan, the set of target business outcomes, and the set of business state information, a set of output data that includes at least a set of revised business plans for achieving the set of target business outcomes, and output the set of output data.

2. The business plan generation device according to claim 1, wherein the first business plan includes:
a first business strategy that characterizes a set of actions to be implemented as part of the first business plan;
a first budget that defines an allotment of resources for use in implementing the first business plan; and
a first set of constraints that define restrictions on implementation of the first business plan.

3. The business plan generation device according to claim 2, wherein the set of target business outcomes include:
a first set of target key performance indicators that indicate a desired degree of performance of the first business with respect to one or more performance metrics;
a first target time frame that indicates a desired time period for achieving the first set of target key performance indicators; and
a first tolerance threshold that defines a permissible range of variation of the first set of target key performance indicators or the first target time frame.

4. The business plan generation device according to claim 3, wherein, the set of business state information includes a number of services offered by a business, a number of customers of a business, a yearly revenue of a business, and a number of shared revenue partners of a business.

5. The business plan generation device according to claim 4, wherein:
the first business and the second business belong to a first business field; and
the business information acquisition unit is configured to generate a revised set of competitor business information by:
performing a web-scraping technique to acquire the set of competitor business information;
identifying a time evolution pattern of the set of competitor business information that characterizes how a business state of the second business evolves over time;
generating, by performing an interpolation technique based on the identified time evolution pattern of the set of competitor business information, a set of predicted data to supplement missing portions of the set of competitor business information; and
assigning, based on a comparison of the first business and the second business, a weight to the second business that indicates a relevance of the second business to the first business.

6. The business plan generation device according to claim 5, further comprising a forecasting unit configured to:
identify a first event that is anticipated to impact the first business field; and
generate, using a statistical analysis technique, a set of forecasting data that includes an impact factor that quantifies an impact of the first event on at least one of the first business or the second business.

7. The business plan generation device according to claim 6, wherein the business plan generation unit is further configured to:
train the machine learning model to generate business plans using a training set created based on the revised set of competitor business information,
configure the machine learning model with a set of hyper parameters determined based on the first business plan and the set of forecasting data;
generate, by using the machine learning model to analyze the first business plan, the set of target business outcomes, and the set of internal business information, a set of revised business plans for achieving the set of target business outcomes;
rank the set of revised business plans based on the degree to which each revised business plan of the set of revised business plans achieves the set of target business outcomes; and
output, as the output data, a ranked list of the set of revised business plans.

8. The business plan generation device according to claim 7, wherein each revised business plan includes at least:
a second business strategy that characterizes a set of actions to be implemented as part of the revised business plan;
a second budget that defines an allotment of resources necessary for implementing the revised business plan;
a second set of target key performance indicators that indicate a predicted degree of performance of the first business with respect to one or more performance metrics; and
a confidence level that indicates an accuracy of the revised business plan.

9. A business plan generation method comprising:
defining a first business plan for a first business by designating a first business strategy that characterizes a set of actions to be implemented as part of the first business plan, a first budget that defines an allotment of resources for use in implementing the first business plan and a first set of constraints that define restrictions on implementation of the first business plan;
defining a set of target business outcomes that indicate desired results of the first business plan by designating a first set of target key performance indicators that indicate a desired degree of performance of the first business with respect to one or more performance metrics, a first target time frame that indicates a desired time period for achieving the first set of target key performance indicators, and a first tolerance threshold that defines a permissible range of variation of the first set of target key performance indicators or the first target time frame;
performing a web-scraping technique to acquire a set of competitor business information that indicates a current state of a second business separate from the first business;
identifying a time evolution pattern of the set of competitor business information that characterizes how a business state of the second business evolves over time;
generating, by performing an interpolation technique based on the identified time evolution pattern of the set of competitor business information, a revised set of competitor business information;
identifying a first event that is anticipated to impact the first business or the second business; and
generating, using a statistical analysis technique, a set of forecasting data that includes an impact factor that quantifies an impact of the first event on at least one of the first business or the second business.
training a machine learning model to generate business plans using a training set created based on the revised set of competitor business information,
configuring the machine learning model with a set of hyper parameters determined based on the first business plan and the set of forecasting data;
generating, by using the machine learning model to analyze the first business plan, the set of target business outcomes, and the set of internal business information, a set of revised business plans for achieving the set of target business outcomes;
ranking the set of revised business plans based on the degree to which each revised business plan of the set of revised business plans achieves the set of target business outcomes; and
outputting, as the output data, a ranked list of the set of revised business plans.

10. A business plan generation system comprising:
a client terminal configured to display a user interface for receiving input data and presenting output data;
an external network configured to provide access to a plurality of data sources;
a data collection server configured to collect business state information from the external network;
a business plan generation device configured to generate business plans; and
an internal network configured to facilitate data communication between the data collection server, the client terminal, and the business plan generation device,
wherein the business plan generation device includes:
a business plan definition unit configured to define, based on a user input to the client terminal via the user interface, a first business plan for a first business and a set of target business outcomes that indicate desired results of the first business plan,
a business information acquisition unit configured to acquire, from the external network using the data collection server, a set of competitor business information that indicates a current state of a second business separate from the first business; and
a business plan generation unit configured to use a machine learning model to generate, based on the first business plan, the set of target business outcomes, and the set of competitor business information, a set of output data that includes at least a set of revised business plans for achieving the set of target business outcomes, and output the set of output data to the user interface of the client terminal.
